(19) United States
(12) Patent Application Publication
(10) Pub. No.: US 2007/0070911 A1
(43) Pub. Date: Mar. 29, 2007

(54) Method for testing links in a wireless network

(76) Inventors: Keith J. Goldberg, Casselberry, FL (US); Charles R. Barker JR., Orlando, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/238,742

(22) Filed: Sep. 29, 2005

(51) Int. Cl. H04J 3/14; H04J 1/16; H04Q 7/24

(52) U.S. Cl. 370/248; 370/252; 370/338

(57) ABSTRACT

A method for testing links in a adhoc wireless network 100 is disclosed. The adhoc wireless network 100 comprises a plurality of nodes 305,310,315,320 linked together using a communication route 345. The method comprising the steps of triggering a link test requirement of a link 340 between a first node 305 and a second node 320 in the adhoc wireless network 100; and performing the link test by the first node 305 sending one or more test packets using one or more link test parameters directly from the first node 305 to the second node 320 irrespective of the communication route 345.

### FIELD OF THE INVENTION

The present invention relates generally to wireless networks and in particular to a layer 2 method for testing links in a wireless network.

### BACKGROUND

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet.

In a wireless network, links between nodes are typically tested by passing data between those nodes. In some adhoc wireless networks, such as a mesh network, the data may not go directly (1 hop) to the destination. In such networks, for example, routing algorithms choose the best path. It would be beneficial to thus ignore the path chosen by routing.

Some systems use feedback from transmission attempts to characterize the quality of the link to the destination node. This typically occurs during network deployment and when analyzing an already deployed network.

A common way to test connectivity is to generate traffic using an application that uses layer 3 protocols, such as ‘ping’ or ‘iperf’. Ping tests whether another node is reachable by sending an Internet Control Message Protocol (ICMP) request message. An ICMP echo reply is expected to be returned if the node is reachable. Iperf is a tool to measure maximum Transmission Control Protocol (TCP) bandwidth, allowing the tuning of various parameters and User Datagram Protocol (UDP) characteristics. Iperf reports bandwidth, delay jitter, datagram loss. These methods are inadequate to test a link between nodes in some adhoc networks such as a mesh network because they are ignorant of the path taken to get from the source to the destination. For example, take a mesh network comprised of 3 nodes: A, B, and C. The desire is to test the link between nodes A and C, but the routing algorithms create a route from A to C through node B. There is no way for an application like ping to ignore the route and force A to communicate directly with C.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communication network including a plurality of nodes employing a system and method in accordance with an embodiment of the present invention.

FIG. 2 is a block diagram illustrating an example of a node employed in the network shown in FIG. 1 in accordance with an embodiment of the present invention.

FIG. 3 is an exemplary communications diagram for implementation of an embodiment of the present invention within the network of FIG. 1.

FIG. 4 is a flowchart illustrating a method for testing links in a wireless networks in accordance with an embodiment the present invention.

FIG. 5 is a flowchart illustrating further detail of the method for testing links of FIG. 4 in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method for testing links in a wireless network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a method for testing links in a wireless network described herein. The non-processor circuits may include, but are not limited to, a radio receiver, a radio transmitter, signal drivers, clock circuits, power source circuits, and user input devices. As such, these functions may be interpreted as steps of a method to perform a method for testing links in a wireless network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and apparatus for testing links in a wireless adhoc network is described herein. The present invention includes a protocol for allowing devices to send test data packets between links using layer 2 Media Access Controls (MAC) addresses. A specialized “Layer 2 Ping” packet is used allowing the protocol to bypass the normal network routing tables, if needed, to send packets directly to a node.

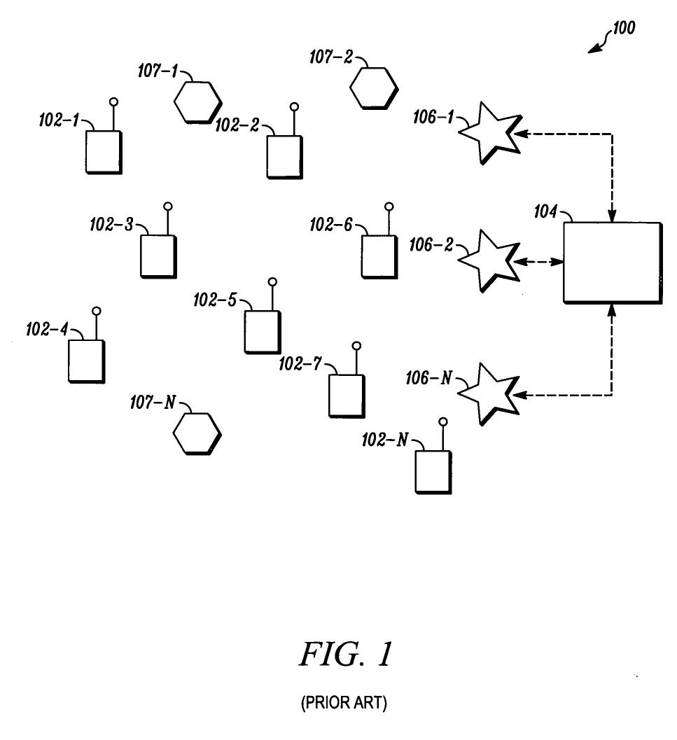

FIG. 1 is a block diagram illustrating an example of an ad-hoc wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes.

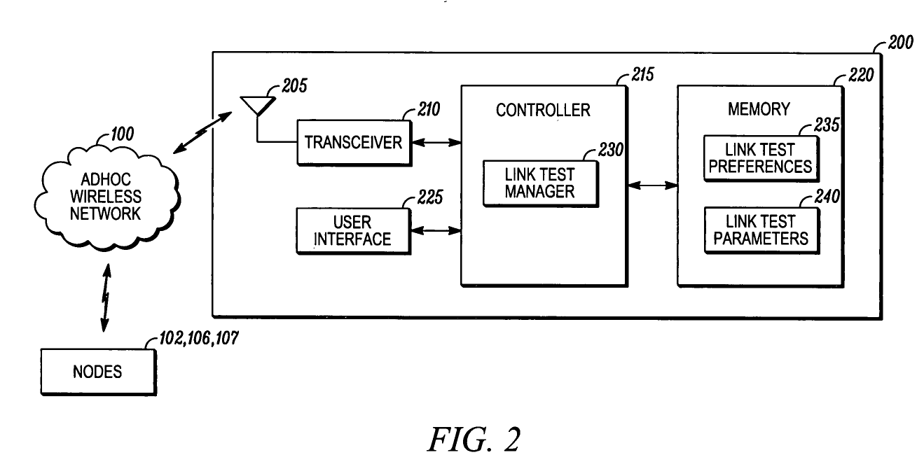

FIG. 2 is an electronic block diagram of one embodiment of the nodes 102, 106, and 107 of FIG. 1. Specifically, FIG. 2 illustrates a node 200 for use with the present invention.

As illustrated, the node 200 includes an antenna 205, a transceiver (or modem) 210, a controller 215, and a user interface 225. The antenna 205 intercepts transmitted signals from one or more nodes 102, 106, 107 within the adhoc wireless network 100 and transmits signals to the one or more nodes 102, 106, 107 within the adhoc wireless network 100.

The antenna 205 is coupled to the transceiver 210, which employs conventional demodulation techniques for receiving and transmitting communication signals, such as packetized signals, to and from the node 200 under the control of the controller 215. The packetized data signals can include, for example, voice, data or multimedia information, and packetized control signals, including node update information. When the transceiver 210 receives a command from the controller 215, the transceiver 210 sends a signal via the antenna 205 to one or more devices within the ad-hoc wireless communications network 100. In an alternative embodiment (not shown), the node 200 includes a receive antenna and a receiver for receiving signals from the ad-hoc wireless communications network 100 and a transmit antenna and a transmitter for transmitting signals to the ad-hoc wireless communications network 100. It will be appreciated by one of ordinary skill in the art that other similar electronic block diagrams of the same or alternate type can be utilized for the node 200.

Coupled to the transceiver 210, is the controller 215 utilizing conventional signal-processing techniques for processing received messages. It will be appreciated by one of ordinary skill in the art that additional processors can be utilized as required to handle the processing requirements of the controller 215.

In accordance with the present invention, the controller 215 includes a link test manager 230 for managing the testing of links in which the node 200 is connected within the adhoc wireless communication network 100. It will be appreciated by those of ordinary skill in the art that the link test manager 230 can be hard coded or programmed into the node 200 during manufacturing, can be programmed over-the-air upon customer subscription, or can be a downloadable application. It will be appreciated that other programming methods can be utilized for programming the link test manager 230 into the node 200. It will be further appreciated by one of ordinary skill in the art that the link test manager 230 can be hardware circuitry within the node 200. In accordance with the present invention, the link test manager 230 can be contained within the controller 215 as illustrated, or alternatively can be an individual block operatively coupled to the controller 215 (not shown).

To perform the necessary functions of the node 200, the controller 215 is coupled to the memory 220, which preferably includes a random access memory (RAM), a read-only memory (ROM), an electrically erasable programmable read-only memory (EEPROM), and flash memory. The memory 220, in accordance with the present invention, includes storage locations for the storage of link test preferences 235, link test parameters, 240, and the like.

The link test preferences 235, for example, can include run link test in response to a message received from the adhoc wireless network 100, run link test in response to a user input to the user interface 225, or run link test in response to a pre-programmed event or condition (time, location, and the like).

The link test parameters 240, for example, can include directionality (bidirectional or omnidirectional), destination preferences, transmission interval, payload size (data load) maximums, and routes that should be ignored.

It will be appreciated by those of ordinary skill in the art that the memory 220 can be integrated within the node 200, or alternatively, can be at least partially contained within an external memory such as a memory storage device. The memory storage device, for example, can be a subscriber identification module (SIM) card. A SIM card is an electronic device typically including a microprocessor unit and a memory suitable for encapsulating within a small flexible plastic card. The SIM card additionally includes some form of interface for communicating with the node 200.

Preferably, the user interface 225 is coupled to the controller 215. The user interface 225 can include a keypad such as one or more buttons used to generate a button press or a series of button presses. The user interface 225 can also include a voice response system or other similar method of receiving a manual input initiated by the device user. The controller 215, in response to receiving a user input via the user interface 225 performs commands as required. It will be appreciated by those of ordinary skill in the art that the user interface 225 can be utilized to perform various functions and make various operational choices for functioning of the node 200. For example, the user interface 225 can be used to provide inputs to the link test manager 230 for performing a layer 2 link test in accordance with the present invention.

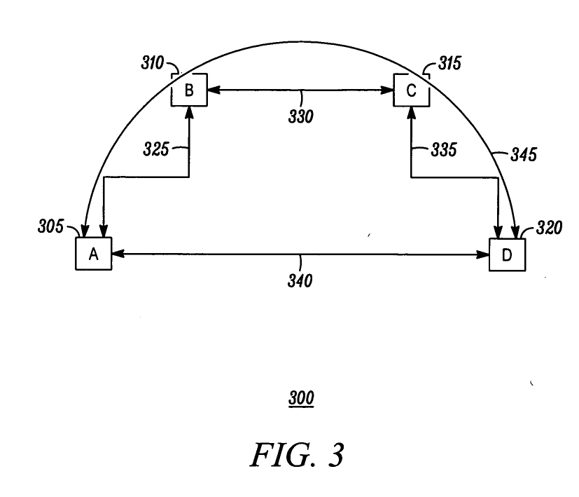

FIG. 3 is an exemplary communications diagram for implementation of an embodiment of the present invention within the network of FIG. 1. The simplified network 300, as illustrated, includes four nodes: node A (305), node B (310), node C (315), and node D (320). Messages within the network 300 are routed using a route 345 comprising the following: from node A (305) to node B (310) via a first link 325, then from node B (310) to node C (315) via a second link 330, then from node C (315) to node D (320) via a fourth link 335. When it is desired to test a fourth link 340 from node A (305) to node D (32), for example, the present invention provides a method to do so by ignoring the route 345 and communicating directly from node A (305) to node D(320) via the fourth link 340.

Specifically, in accordance with the present invention, a message can be sent between node D (320) and node A (305) which allows the two devices to send test data packets between links using layer 2 MAC addresses. An API is defined which includes the destination MAC, the size of the test packet, whether the test packet should be routed or sent directly, the frequency of packet generation, whether the destination should reply to the test packet, a time interval to generate test packets, and a method to stop the generation of test packets before the time interval has expired.

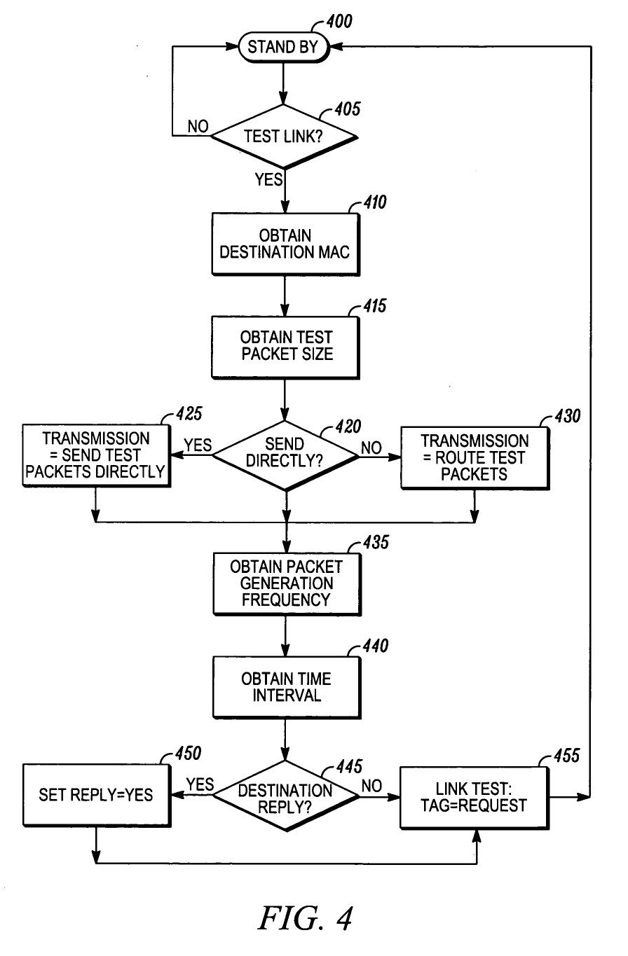

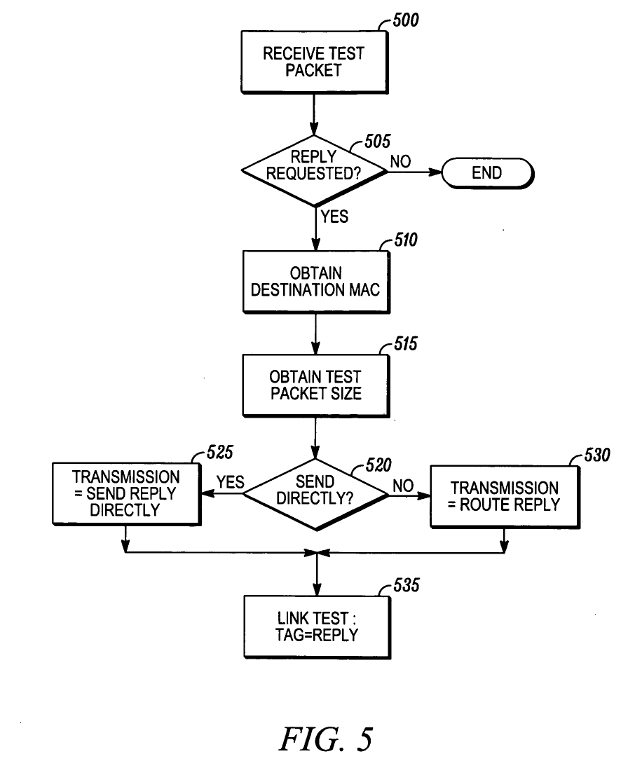

FIG. 4 and FIG. 5 are flowcharts illustrating a method for testing links in an adhoc wireless network in accordance with the present invention. The method of FIG. 4, for example, can be programmed into the link test manager 230 of the node 200 or can be programmed into one or more other devices within the wireless adhoc communication network 100. Preferably, the communications included within the operations of FIGS. 4 and 5 are accomplished as layer 2 operations.

As illustrated in FIG. 4, the operation begins at Step 400 with the node 200 in standby mode. Next, in Step 405, the operation determines whether or not a link test is required/desired. In one embodiment, the node 200 is preprogrammed with one or more link test preferences 235 which trigger a link test requirement of a link between node 200 and another node in the network 100. In another embodiment, a user input to the user interface 225 of the node 200 triggers a link test requirement. In another embodiment, the node 200 receives a message indicating a link test requirement from another node in the network 100. The message, in accordance with the present invention, can be received from the other node connected to the link (i.e. from node A 305 to node D 320 for a link test of link 340 of FIG. 300), or can be received from any other node within the network 100 programmed to manage link tests. When a link test is not required in Step 405, the operation cycles back to the standby mode Step 400 and periodically repeats the query of Step 405.

When a link test is required/desired in Step 405, the operation continues with Step 410 in which the link test manager 230 of the node 200 obtains the destination MAC associated with the required link test. In one embodiment, a destination MAC associated with each link in which the node 200 is currently operating can be stored in the memory 220 (i.e. within the link test parameters 240) of the node 200 for use in Step 410 as needed. In another embodiment, a user input to the user interface 225 of the node 200 provides the destination MAC. In another embodiment, the node 200 receives a message including the destination MAC. The destination MAC, for example, can be included in the message indicating a link test requirement from another node in the network 100 or in a separate message. The destination MAC, for example can be the destination MAC of node A 305 to node D 320 for a link test of link 340 of FIG. 300).

Next, in Step 415, the node 200 obtains the test packet size for the required link test. In one embodiment, the test packet size associated with each link in which the node 200 is currently operating can be stored in the memory 220 (i.e. within the link test parameters 240) of the node 200 for use in Step 415 as needed. In another embodiment, a user input to the user interface 225 of the node 200 provides the test packet size. In another embodiment, the node 200 receives a message including the test packet size. The test packet size, for example, can be included in the message indicating a link test requirement from another node in the network 100 or in a separate message.

Next, in Step 420, the process determines whether the test packet should be routed or sent directly. When the test packet is to be sent directly in Step 420, the operation continues to Step 425 in which the test packet is prepared to send directly. To illustrate, in the network 300 of FIG. 3, the test packet would be sent directly from node A 305 to node D 320 for testing the link 340. When the test packet is to be routed in Step 420, the operation continues with Step 430 in which the test packet is prepared to be routed. To illustrate, in the network 300 of FIG. 3, the test packet would be sent from node A 305 to node B 310 to node C 315 to node D 320 via the route 345.

After Steps 425 and 430, the operation continues with Step 435 in which the node 200 obtains the packet generation frequency. In one embodiment, the packet generation frequency associated with each link in which the node 200 is currently operating can be stored in the memory 220 (i.e. within the link test parameters 240) of the node 200 for use in Step 410 as needed. In another embodiment, a user input to the user interface 225 of the node 200 provides the packet generation frequency. In another embodiment, the node 200 receives a message including the packet generation frequency. The packet generation frequency, for example, can be included in the message indicating a link test requirement from another node in the network 100 or in a separate message.

Next, in Step 440, the node 200 obtains the time interval to generate test packets for the link test. In one embodiment, the time interval associated with each link in which the node 200 is currently operating can be stored in the memory 220 (i.e. within the link test parameters 240) of the node 200 for use in Step 410 as needed. In another embodiment, a user input to the user interface 225 of the node 200 provides the time interval. In another embodiment, the node 200 receives a message including the time interval. The time interval, for example, can be included in the message indicating a link test requirement from another node in the network 100 or in a separate message.

Next, in Step 445, the node 200 determines whether or not the destination node should reply to the test packet. In one embodiment, the reply requirement associated with each link in which the node 200 is currently operating can be stored in the memory 220 (i.e. within the link test parameters 240) of the node 200 for use in Step 410 as needed. In another embodiment, a user input to the user interface 225 of the node 200 provides the reply requirement. In another embodiment, the node 200 receives a message including the reply requirement. The reply requirement, for example, can be included in the message indicating a link test requirement from another node in the network 100 or in a separate message. When a reply is required by the destination in Step 445, the operation continues to Step 450 in which a parameter is set to indicate a requested reply from the destination. When no reply is required in Step 445 and after Step 450, the operation continues to Step 455 in which the link test is performed using all the parameters previously described herein. Optionally, each test packet can be tagged as a request test packet for the link test. The operation then cycles back to the standby mode Step 400 and periodically to Step 405 to determine if another link test is required/desired.

FIG. 5 is a flowchart illustrating further detail of the method for testing links of FIG. 4 in accordance with an embodiment of the present invention. Specifically, FIG. 5 illustrates one embodiment of the operation of a destination node when a reply is set to “yes” in Step 450 of FIG. 4. For example, when the link 340 of FIG. 3 is being tested, the operation of FIG. 5 would occur at node D 320 in response to receiving a test packet from node A 305 either directly or through route 345.

As illustrated in FIG. 5, the operation begins at Step 500 in which the receiving node receives a test packet from the sending node. (i.e. node D receives a test packet from node A). Next, in Step 505 the receiving node determines whether or not a reply has been requested. In one embodiment, a reply request is included within the received test packet. For example, the node A 305 sets a parameter within the test packet message indicating a reply is requested. In another embodiment, the receiving node includes a preset reply condition stored in memory for the receiving node. A link manager within the receiving node compares the sending nodes identification to those stored in memory and determines whether or not a reply is required. When no reply is requested or required, the operation ends.

When a reply is requested or required in Step 505, the operation continues with Step 510 in which the receiving node obtains the destination MAC associated with the required link test. In one embodiment, the test packet received includes the destination MAC. The destination MAC, for example can be the destination MAC of node A 305 for replying to a test packet received from node D 320 in association with a link test of link 340 of FIG. 300. In another embodiment, a destination MAC associated with each link in which the receiving node is currently operating can be stored in the memory (i.e. within the link test parameters) of the node for use in Step 510 as needed. In another embodiment, a user input to the user interface of the receiving node provides the destination MAC.

Next, in Step 515, the receiving node obtains the test packet size for the required link test. In one embodiment, the receiving node receives the test packet size within or along with the test packet. In another embodiment, the test packet size associated with each link in which the receiving node is currently operating can be stored in the memory (i.e. within the link test parameters) of the receiving node for use in Step 515 as needed. In another embodiment, a user input to the user interface 225 of the receiving node provides the test packet size.

Next, in Step 520, the process determines whether the reply should be routed or sent directly. When the reply is to be sent directly in Step 520, the operation continues to Step 525 in which the reply is prepared to send directly. To illustrate, in the network 300 of FIG. 3, the reply would be sent directly from node D 320 to node A 305 in reply to a test packet received from node A 305 by node D 320 for testing the link 340. When the reply is to be routed in Step 520, the operation continues with Step 530 in which the reply is prepared to be routed. To illustrate, in the network 300 of FIG. 3, the reply would be sent from node D 320 to node C 315 to node B 310 to node A 305 via the route 345.

After Steps 525 and 530, the operation continues with Step 535 in which the reply is sent using all the parameters previously described herein. Optionally, each reply can be tagged as a reply test packet for the link test.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for testing links in an adhoc wireless network, the adhoc wireless network comprising a plurality of nodes linked together using a communication route, the method comprising the steps of:
triggering a link test requirement of a link between a first node and a second node in the adhoc wireless network; and
performing the link test by the first node sending one or more test packets using one or more link test parameters directly from the first node to the second node irrespective of the communication route.

2. The method for testing links in an adhoc wireless network as claimed in claim 1, further comprising the step of:
tagging each of the test packets as a request test packet prior to sending the one or more test packets.

3. The method for testing links in an adhoc wireless network as claimed in claim 1, wherein the method is programmed into one or more devices within the wireless adhoc network.

4. The method for testing links in an adhoc wireless network as claimed in claim 1, wherein the sending of the test packets comprises a layer 2 operation.

5. The method for testing links in an adhoc wireless network as claimed in claim 1, wherein the trigger step comprises:
triggering a link test requirement in response to one or more link test preferences programmed into the first node.

6. The method for testing links in an adhoc wireless network as claimed in claim 1, wherein the trigger step comprises:
triggering a link test requirement in response to a user input to a user interface of the first node.

7. The method for testing links in an adhoc wireless network as claimed in claim 1, wherein the trigger step comprises:
triggering a link test requirement in response to the first node receiving a message indicating a link test requirement from the second node.

8. The method for testing links in an adhoc wireless network as claimed in claim 1, wherein the trigger step comprises:
triggering a link test requirement in response to the first node receiving a message indicating a link test requirement from a third node within the adhoc wireless network.

9. The method for testing links in an adhoc wireless network as claimed in claim 1, further comprising prior to the performing the link test step, the step of:
obtaining the link test parameters by the first node,
wherein the obtaining step comprises obtaining the link test parameters from a memory of the first node.

10. The method for testing links in an adhoc wireless network as claimed in claim 1, further comprising prior to the performing the link test step, the step of:
obtaining the link test parameters by the first node,
wherein the obtaining step comprises:
receiving a user input via a user interface of the first node, and
obtaining the link test parameters from the user input.

11. The method for testing links in an adhoc wireless network as claimed in claim 1, further comprising prior to the performing the link test step, the step of:
obtaining the link test parameters by the first node,
wherein the obtaining step comprises:
receiving a message including the link test parameters from the second node, and
obtaining the link test parameters from the received message.

12. The method for testing links in an adhoc wireless network as claimed in claim 1, further comprising prior to the performing the link test step, the step of:
obtaining the link test parameters by the first node,
wherein the obtaining step comprises:
receiving a message including the link test parameters from a third node, and
obtaining the link test parameters from the received message.

13. The method for testing links in an adhoc wireless network as claimed in claim 1, wherein the link test parameters include one or more parameters selected from a group of parameters comprising a destination MAC, a test packet size, a test packet routing, a packet generation frequency, a time interval to generate test packets, and a reply requirement.

14. The method for testing links as claimed in claim 13, wherein the link test parameters include a test packet routing, and further wherein the test packet routing includes instructions to send one or more test packets directly from the first node to the second node.

15. The method for testing links as claimed in claim 13, wherein the link test parameters includes a reply requirement, the method further comprising at the second node:
receiving a test packet from the first node;
determining that a reply is requested;
obtaining one or more reply parameters; and
sending a reply test packet to the first node using the one or more reply parameters.

16. The method for testing links as claimed in claim 15, wherein the reply request comprises a reply request selected from a group comprising a reply request included in the received test packet, a preset reply condition stored in a memory of the second node, and a reply request associated with an identification of the first node.

17. The method for testing links as claimed in claim 15, wherein each of the reply parameters are obtained by the second node from one or more of a group of parameters comprising link test parameters stored in a memory of the second node, link test parameters input into a user interface of the second node, link test parameters received from the first node, and link test parameters received from a third node.

18. The method for testing links as claimed in claim 15, wherein the reply parameters comprises one or more reply parameters selected from a group comprising a destination MAC, a reply test packet size, and a reply test packet routing.

19. The method for testing links as claimed in claim 18, wherein the reply parameters include a reply test packet routing, and further wherein the reply test packet routing includes instructions to send the reply test packet directly from the second node to the first node.

20. The method for testing links as claimed in claim 15, further comprising the step of:
tagging the reply as a reply test packet prior to transmitting the reply.
